(19) United States
(12) Patent Application Publication
(10) Pub. No.: US 2025/0206462 A1
(43) Pub. Date: Jun. 26, 2025

(54) IMAGE PROJECTOR FOR AIRCRAFT

(71) Applicant: Airbus Operations S.L.U., GETAFE (ES)

(72) Inventors: Rafael VILLANUEVA MONTERO, GETAFE (ES); Maria Aranzazu GARCÍA PATINO, GETAFE (ES); Enrique GUINALDO FERNANDEZ, GETAFE (ES)

(21) Appl. No.: 18/987,501

(22) Filed: Dec. 19, 2024

(30) Foreign Application Priority Data
Dec. 21, 2023 (ES) 202331071

(51) Int. Cl. B64D 47/02; B64C 5/00; B64F 5/10

(52) U.S. Cl. CPC B64D 47/02; B64F 5/10; B64C 5/00

(57) ABSTRACT

An image projector to be installed in a space used for placing a dead mass to mitigate aeroelastic vibrations suffered by the horizontal stabilizer of an aircraft. The image projector replaces the dead mass. The image projector may be connectable to the surface of a closed rib of the horizontal stabilizer. The image projector may include a structural features configured to mitigate at least the same aeroelastic vibrations as the dead mass. The image projector is configured to project at least one image.

### CROSS-REFERENCES TO RELATED APPLICATIONS

This application claims the benefit of Spanish Patent Application Number 202331071 filed on Dec. 21, 2023, the entire disclosure of which is incorporated herein by way of reference.

### FIELD OF THE INVENTION

The present invention relates to an image projector configured to be used as a replacement for a dead mass in order to mitigate aeroelastic vibrations suffered by the tail plane of an aircraft and to project images onto different surfaces.

### BACKGROUND OF THE INVENTION

Aeroelastic vibration or flutter is defined as an unstable, self-excited structural oscillation at a defined frequency in which energy is extracted from the air stream by the movement of the structure.

In state-of-the-art aircrafts, the tail planes include elements known as dead mass (e.g., of stainless steel material) that are located (e.g., by riveting) at the outer ends of the horizontal stabilizer side boxes. These dead masses achieve a reduction or mitigation of the aeroelastic flutter suffered by the horizontal stabilizer because said dead masses allow the resonance frequency of the horizontal stabilizer to move away from the frequency components present during flight. More specifically, dead masses can be established in the front and rear spars and the closed rib of the horizontal stabilizer.

Dead masses prevent the coupling between the overall deflection of the aircraft's horizontal stabilizer and the tail plane elevator rotation and therefore dead masses are mandatory for aircraft stability during flight and cannot be eliminated.

FIG. 1 shows a view of a prior art horizontal stabilizer (1050) having a dead mass (1000) established on the closed rib (1010). Also shown is a dead mass (1000) connected to a spar of the horizontal stabilizer (1050).

FIG. 2 shows parts of a wing (1100) of a state-of-the-art aircraft comprising the horizontal stabilizer (1050) shown in FIG. 1 and where the location of the dead masses (1000) described in FIG. 1 can be seen, both on the closed rib (1010) and on the spar of the horizontal stabilizer (1050).

The identification of “dead” implies that they have no use or functionality beyond the prevention of adverse aeroelastic phenomena.

Due to technological progress, there is a demand for the integration of additional devices that offer new functionalities to the aircraft, without adding more weight to the aircraft structure and respecting the function of the dead masses.

The present invention meets this demand. The present invention allows increasing the functionalities of the aircraft, without modifying its total mass, in such a way that it does not consume more energy for its flight.

### SUMMARY OF THE INVENTION

The present invention proposes a novel use for tail plane spaces intended for dead masses by implementing an image (or video) projector, replacing a dead mass. The image projector comprises one or more structural features equivalent to said dead mass, allowing to maintain the aeroelastic flutter mitigation functionality obtained with the dead mass, while allowing the projection of images/video.

The main benefit of the present invention may include marketing through the implementation of an advertising platform that can be customized according to the needs of the client, achieving savings in paint and great flexibility on the part of the airline in terms of what it wants to show on the surface of the aircraft.

The invention aims at replacing one or more dead masses with useful weight, said useful weight comprising one or more projectors for projecting information onto the surface of the aircraft (vertical stabilizer, or fuselage) or onto solid ground, in the form of images or video.

The projector according to the present invention offers all the functionalities of current projectors. The projector allows projecting a static image on different surfaces, such as, for example, the logo of an airline, or to offer a dynamic and customizable solution that projects different images at a time interval on the surface of the vertical stabilizer, as well as video.

Furthermore, due to its location on the closed rib of the horizontal stabilizer, it can also project images/video on other surfaces of the aircraft such as the fuselage and even on solid ground. The placement of the projector on the closed rib of the horizontal stabilizer is not arbitrary, since such location is particularly beneficial due to its maximum distance from the joining area of the horizontal stabilizer with the fuselage. The replacement of a dead mass by the projector according to the present invention increases the functionalities of the aircraft without adding additional mass to the tail of the aircraft. Indeed, adding mass to the aircraft, and in particular in the tail area of the aircraft, would decrease the efficiency of the aircraft in flight. Therefore, the replacement of a dead mass by a projector (and not the simple addition of the projector to the tail of the aircraft) is an essential requirement of the present invention.

The main aspect of the present invention relates to an image projector configured to be installed in a space provided for placing a dead mass for mitigating aeroelastic vibrations of the horizontal stabilizer of an aircraft wing, where the image projector is adapted to replace said dead mass, wherein the image projector may be connected to the horizontal stabilizer and may be integrated into the internal volume of the wing tip of the aircraft, wherein the image projector comprises one or more structural features adapted, in particular a mass adapted, to mitigate at least the same aeroelastic vibrations as the dead mass, wherein the image projector is configured to project an image. In one example, the image projector is connectable to the surface of a closed rib of the horizontal stabilizer.

In one example, the image projector is configured to project an image onto solid ground, onto the vertical stabilizer, or onto the fuselage of the aircraft.

In one example, the image projector comprises a battery.

In one example, structural features comprise at least weight and/or volume.

A second aspect of the invention relates to an aircraft comprising a horizontal stabilizer comprising an image projector according to the first aspect of the invention, wherein the image projector has a mass suitable for mitigating aeroelastic vibrations of the horizontal stabilizer.

In a particular embodiment according to the second aspect of the invention, the horizontal stabilizer is free of dead masses.

In another particular embodiment according to the second aspect of the invention, the horizontal stabilizer comprises a closed rib and the image projector is fixed to the closed rib.

In a particular embodiment according to the second aspect of the invention, the aircraft comprises a wing tip comprising a window adapted to let through a beam of light produced by the projector.

A third aspect of the present invention relates to a method for establishing an image projector in replacement of a dead mass for mitigating aeroelastic vibrations that is connected to the horizontal stabilizer of an aircraft, the method comprising removing the dead table from the horizontal stabilizer of the aircraft, connecting the image projector to the surface of the horizontal stabilizer of the aircraft in replacement of the dead mass, wherein the image projector has a mass suitable for mitigating aeroelastic vibrations of the horizontal stabilizer. The projector frame can be adapted so that its connection to the horizontal stabilizer is made through the same connection points where the dead mass was attached to the horizontal stabilizer.

In a particular embodiment of a method according to the invention, the wing tip that closes the wing in an aerodynamic manner is replaced by a wing tip comprising a window adapted to let through a beam of light produced by the projector.

In a particular embodiment, connecting the image projector to the surface of the horizontal stabilizer comprises fixing the image projector to a closed rib of the horizontal stabilizer.

### BRIEF DESCRIPTION OF THE DRAWINGS

To complement the description being made and in order to assist in a better understanding of the features of the image projector according to the present invention, as an integral part of said description, a number of schematic figures are included, wherein, for illustrative and non-limiting purposes, the following have been represented:

FIG. 1 shows a segment of a prior art horizontal stabilizer comprising dead masses.

FIG. 2 shows the horizontal stabilizer of FIG. 1 as part of an aircraft wing.

FIG. 3 shows an example of a projector according to the present invention connected to the closed rib of the horizontal stabilizer.

FIG. 4 shows a first example of projector of FIG. 3 integrated inside the wing tip volume.

FIG. 5 shows a second example of projector of FIG. 3 integrated inside the wing tip volume.

FIG. 6 shows a top view of an aircraft with different projections from a projector according to the present invention.

FIG. 7 shows a front view of an aircraft with different projections from a projector according to the present invention.

### DETAILED DESCRIPTION OF THE PREFERRED EMBODIMENTS

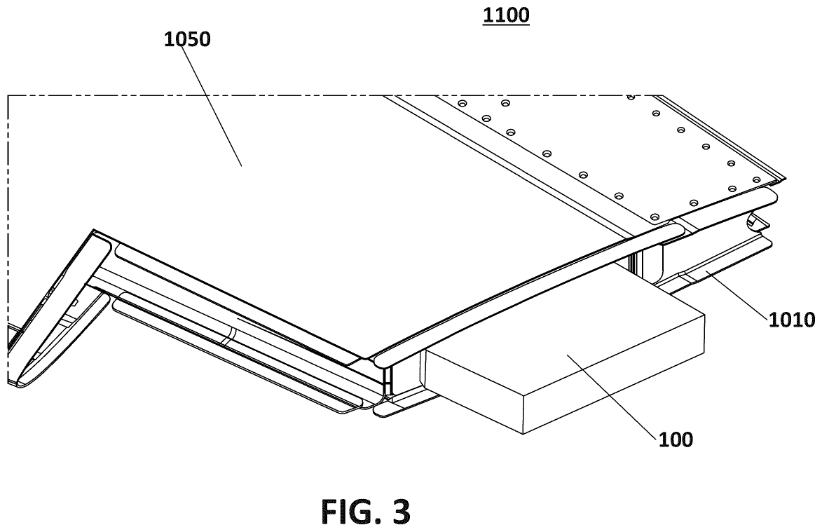

FIG. 3 shows an example of an image projector (100) configured to be installed in a space intended for placing a dead mass (1000) used to mitigate aeroelastic vibrations suffered by the horizontal stabilizer (1050) of an aircraft. The image projector (100) may comprise a housing, preferably rectangular, which allows the image projector (100) to comprise a volume similar to that of the dead mass (1000).

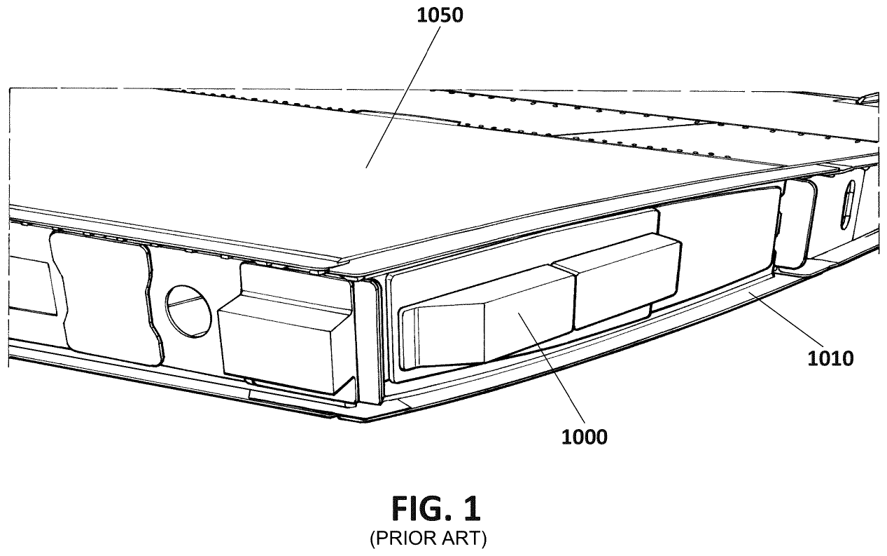

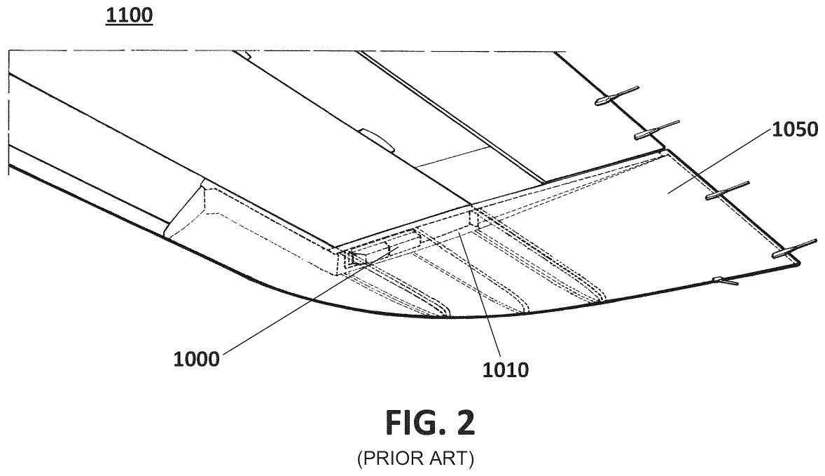

FIG. 3 also shows the horizontal stabilizer (1050) described in FIGS. 1 and 2. The image projector (100) according to the present invention replaces said dead mass (1000) shown in FIG. 1. In this particular example, the image projector (100) is connected to the surface of the closed rib (1010) of the horizontal stabilizer (1050).

The image projector (100) comprises structural features, for example, weight and/or volume adapted to mitigate at least the same aeroelastic vibrations as the dead mass (1000) shown in FIGS. 1 and 2.

In the main embodiment, the image projector (100) is connected by power cables to the rest of the aircraft (e.g. as the lights).

The image projector (100) is configured to project an image (110) onto the surface of the aircraft such as the cockpit fuselage or the vertical stabilizer.

The image projector (100) is configured to project at least one image (110) onto solid ground, onto the vertical stabilizer or onto the fuselage of the aircraft.

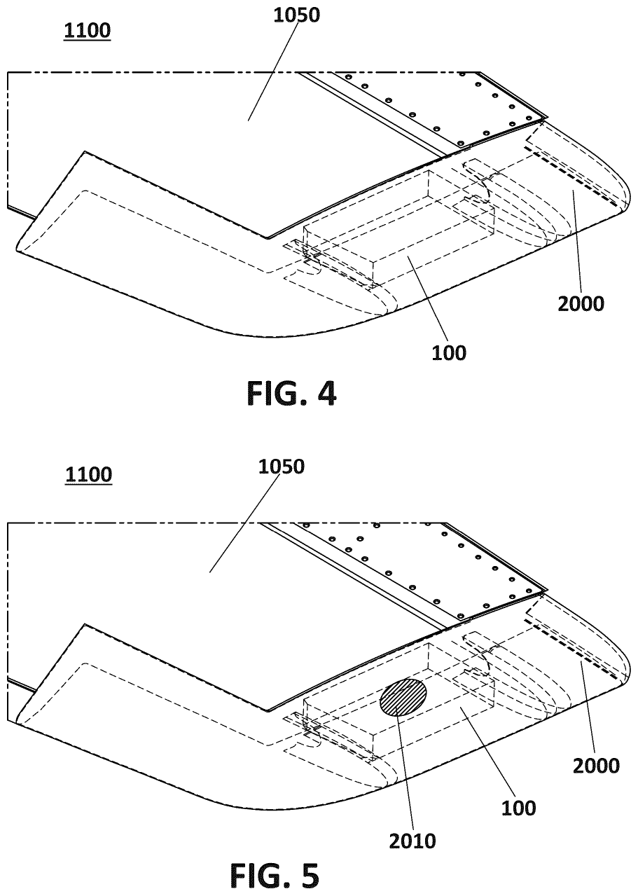

FIG. 4 shows the image projector (100) configured to be installed in the space provided for placing the dead mass (1000), and wherein the image projector (100) is connected to the surface of the closed rib (1010) of the horizontal stabilizer (1050) of the horizontal stabilizer (1100) of the aircraft. FIG. 4 also shows how the image projector (100) is integrated into the internal volume of the wing tip (2000) of the horizontal stabilizer (1100) of the aircraft.

FIG. 5 shows the image projector (100) integrated into the internal volume of the wing tip (2000) of the horizontal stabilizer (1100) of the aircraft, and wherein the wing tip (2000) comprises a window (2010) coinciding with the projector lamp (not shown in the figures), allowing the passage of the projection through the skin of the wing tip (2000).

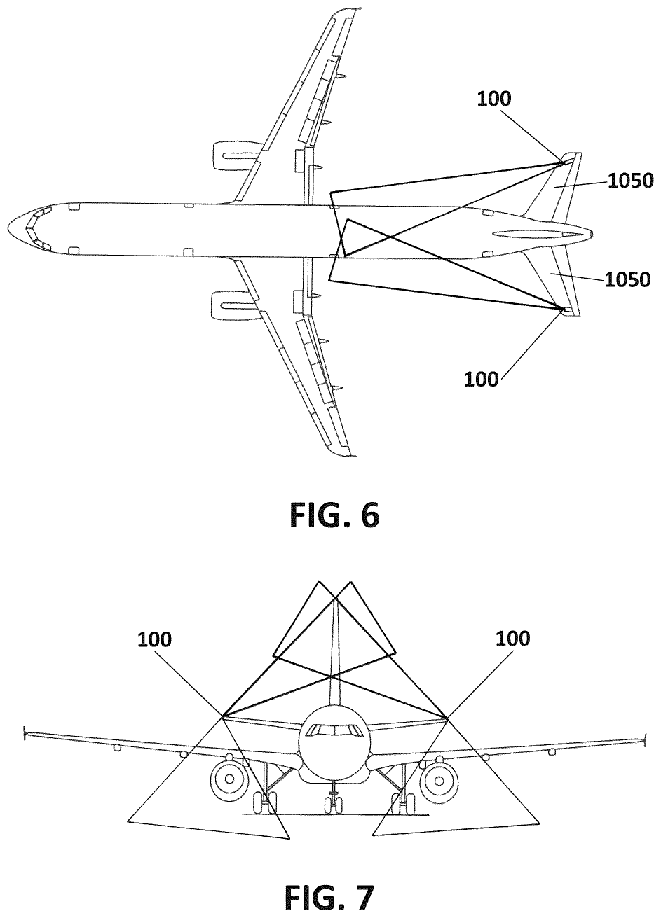

FIGS. 6 and 7 show different projections of two image projectors (100) according to the present invention. The two image projectors (100) are connected to the closed ribs (1010) of the horizontal stabilizers (1050) of the aircraft, placed in spaces usually provided for placing the dead masses (1000) shown in FIGS. 1 and 2, and replacing the dead masses (1000). A first image projector (100) is established on a first horizontal stabilizer (1050) of a first wing of the aircraft. A second image projector (100) is established on a second horizontal stabilizer (1050) of a second wing of the aircraft.

In FIG. 6, the image projectors (100) are configured to project images onto the aircraft fuselage.

In FIG. 7, the image projectors (100) are configured to project images onto solid ground.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An image projector configured to be installed in a space provided for placing a dead mass for mitigating aeroelastic vibrations of a horizontal stabilizer of an aircraft,
wherein the image projector replaces said dead mass,
wherein the image projector is connected to the horizontal stabilizer and integrated into an interior volume of a wing tip of a wing of the aircraft;
wherein the image projector comprises structural features configured to mitigate at least a same aeroelastic vibrations as the dead mass; and
wherein the image projector is configured to project at least one image.

2. The image projector according to claim 1, wherein the image projector is configured to project at least one image onto solid ground, onto a vertical stabilizer, or onto a fuselage of the aircraft.

3. The image projector according to claim 1, wherein the image projector is configured to be connected to a surface of a closed rib of the horizontal stabilizer.

4. The image projector according to claim 1, further comprising a battery.

5. The image projector according to claim 1, further comprising a housing.

6. The image projector according to claim 1, wherein the structural features comprise at least weight, or volume, or both.

7. An aircraft comprising:
a horizontal stabilizer comprising the image projector according to claim 1,
wherein the image projector has a mass suitable for mitigating aeroelastic vibrations of the horizontal stabilizer.

8. The aircraft according to claim 7, wherein the horizontal stabilizer comprises a closed rib.

9. The aircraft according to claim 8, wherein the image projector is fixed to the closed rib.

10. A method for mitigating aeroelastic vibrations with an image projector in an aircraft, the method comprising:
removing a dead mass from a horizontal stabilizer of the aircraft;
connecting an image projector to a surface of the horizontal stabilizer of the aircraft as a replacement for the dead mass,
wherein the image projector has a mass suitable to mitigate aeroelastic vibrations of the horizontal stabilizer.

11. The method according to claim 10, wherein connecting the image projector to the surface of the horizontal stabilizer comprises fixing the image projector to a closed rib of the horizontal stabilizer.
